(19) United States
(12) Patent Application Publication
(10) Pub. No.: US 2001/0027527 A1
(43) Pub. Date: Oct. 4, 2001

(54) Secure transaction system

(76) Inventors: Yuri Khidekel, Lafayette, CA (US); Alex Balashov, San Ramon, CA (US); Vladimir Bashmakov, Walnut Creek, CA (US)

Correspondence Address: WILLIAM J. EGAN, III, Fish & Richardson P.C., 45 Rockefeller Plaza, Suite 2800, New York, NY, 10111, US

(21) Appl. No.: 09/792,391

(22) Filed: Feb. 23, 2001

Related U.S. Application Data
(60) Provisional application No. 60/184,958, filed on Feb. 25, 2000.

(51) Int. Cl. H04L 9/00; H04L 9/32; G06F 11/30; G06F 12/14

(52) U.S. Cl. 713/201

(57) ABSTRACT

Techniques for providing secure transactions can include receiving a request for access to a first server by a user. The request includes the user's credentials such as biometric information, an electronic certificate, or other information. The user is authenticated based on the credentials, and a token is sent to the first server. The token indicates whether the user has been authenticated and includes criteria about the user. Based on the criteria in the token, the first server can determine whether the user is authorized to perform a particular transaction in connection with a specified file or application at the first server. The user can be re-authenticated prior to allowing the transaction to be completed. Each time the user is authenticated, a time-stamped record can be stored. Encryption can be used to enhance security.

### CROSS-REFERENCE TO RELATED APPLICATIONS

This application claims the priority of U.S. Provisional Patent Application No. 60/184,958, filed on Feb. 25, 2000.

### BACKGROUND

The present invention relates generally to secure transaction systems.

To facilitate secure electronic communications over public networks such as the Internet, parties engaging in applications such as electronic commerce (ecommerce) should be able to authenticate each other. Authentication is the process of verifying the identity of a party.

The need for secure, authenticated transactions and communications through the Internet and wireless systems already is great. Numerous transactions each day already need secure, trusted protection. Exploding Internet and wireless usage will likely dramatically increase this requirement. Online electronic commerce, secure electronic mail (email), and delivery of new services needing security and copy protection are being implemented and widely adopted. Cell phone usage is expected to grow dramatically, in part due to increasing integration and compatibility of smart-phones with Internet communications. More people using a broader range of transactions and communications are creating increased demand for trusted, secure, authenticated and protected communications.

### SUMMARY

In general, techniques for providing secure transactions are described. According to one aspect, a method includes receiving a request by a user for access to a first server and receiving a token at the first server. The token indicates that the user has been authenticated and identifies a role assigned to the user. A determination is made, based at least in part on the role identified in the token, whether the user is permitted to perform a particular transaction in connection with a specified file or application at the first server.

In a related aspect, a method includes receiving a request for access to a first server by a user. The request includes the user's credentials such as biometric information, an electronic certificate, or other information. The user is authenticated based on the credentials, and a token is sent to the first server. The token indicates whether the user has been authenticated and includes criteria about the user. Based on the criteria in the token, the first server can determine whether the user is permitted to perform a particular transaction in connection with a specified file or application at the first server. The user can be re-authenticated prior to allowing the transaction to be completed.

The techniques can be used with various types of transactions including, for example, access to, modification of, forwarding of, and/or printing of files or applications at the first server.

Each time the user is authenticated, a time-stamped record can be stored. Encryption can be used to enhance security. User profiles, user credentials and time-stamped records can be stored in encrypted form in a database associated with an authentication server. Information sent to the first server can be encrypted, for example, with a shared key.

The user criteria included in the token can identify, for example, a role assigned to the user. That information can be used in conjunction with a business rule associated with a particular file or application at the first server to determine whether the user is authorized to perform a particular transaction.

Systems for implementing these and other features are described in greater detail below.

The techniques can help guarantee that the authorized person is actually the person conducting the transaction. The combined services provided by the system can help ensure that a service subscriber, rather than an authorized device, such as a credit card or personal computer, is being identified and served. The system also can include encryption and protection of contents. Audit trails and non-repudiation can be supported.

Examples of applications that may benefit from use of the techniques are secure email, authorization to access specific databases or services, secure information and storage/access, Web security, authentication for specific customer applications (e. g., voice/telephone/video service), and secure information distribution.

Other features and advantages will be readily apparent from the following detailed description, accompanying drawings, and the claims.

### BRIEF DESCRIPTION OF THE DRAWINGS

FIG. 1 illustrates a secure transaction system.

FIG. 2 illustrates obtaining access to secure on-line services through an authentication server.

FIG. 3 illustrates an enrollment page.

FIG. 4 is a flow chart of a method for performing a secure transaction.

FIG. 5 illustrates an electronic token.

### DETAILED DESCRIPTION

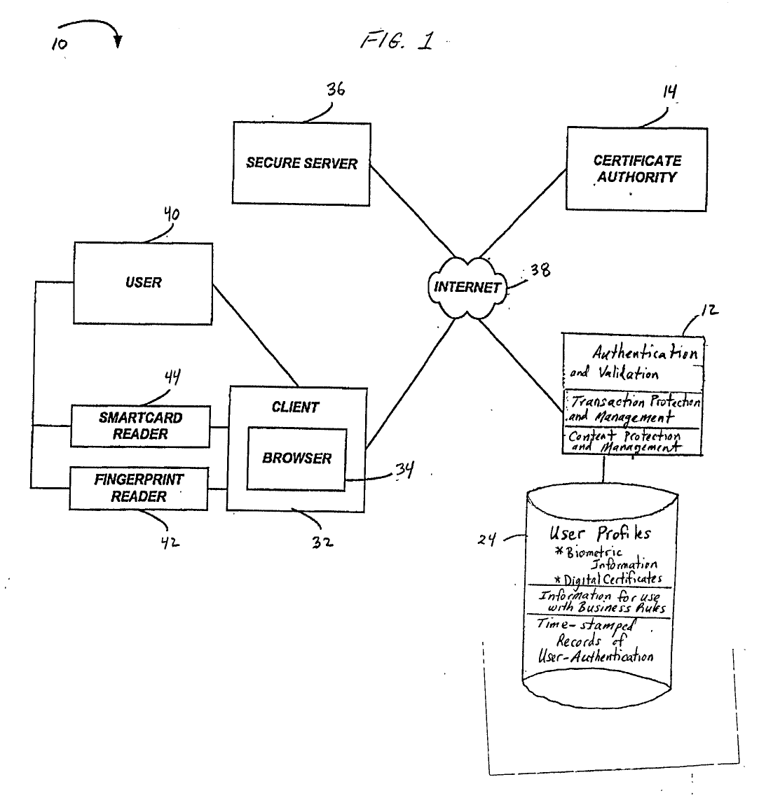

As illustrated in FIG. 1, a secure transaction system 10 includes an authentication server 12 that provides authentication and validation of an entity that wishes to perform a transaction, transaction protection and management, and content protection and management. In this context, a “transaction” includes an activity involving access to, modification of, or transmittal of electronic information. A client/server architecture can be employed in which the authentication server 12 interacts with enabled client devices 32, such as personal computers, wireless devices and personal digital assistants (PDAs). The services provided by the authentication server 12 can be implemented, for example, either as an independent, central service or as a licensed software suite provided to individual businesses or organizations. A fully integrated, secure trusted transaction system can be provided.

The services provided by the authentication server 12 can be implemented as part of a secure transaction system in any one of several business models. In general, depending on the particular business model employed, the enrollment of users, the hosting of secure transaction services and the management of secure transaction services may be performed by the same or different entities. In one model, the authentication server 12 is located at a customer's premises. The customer would then manage the system, including enrollment of users, and a central service would provide technical support. In a consumer model, a third-party would perform the task of enrolling users with the infrastructure being provided by a central service.

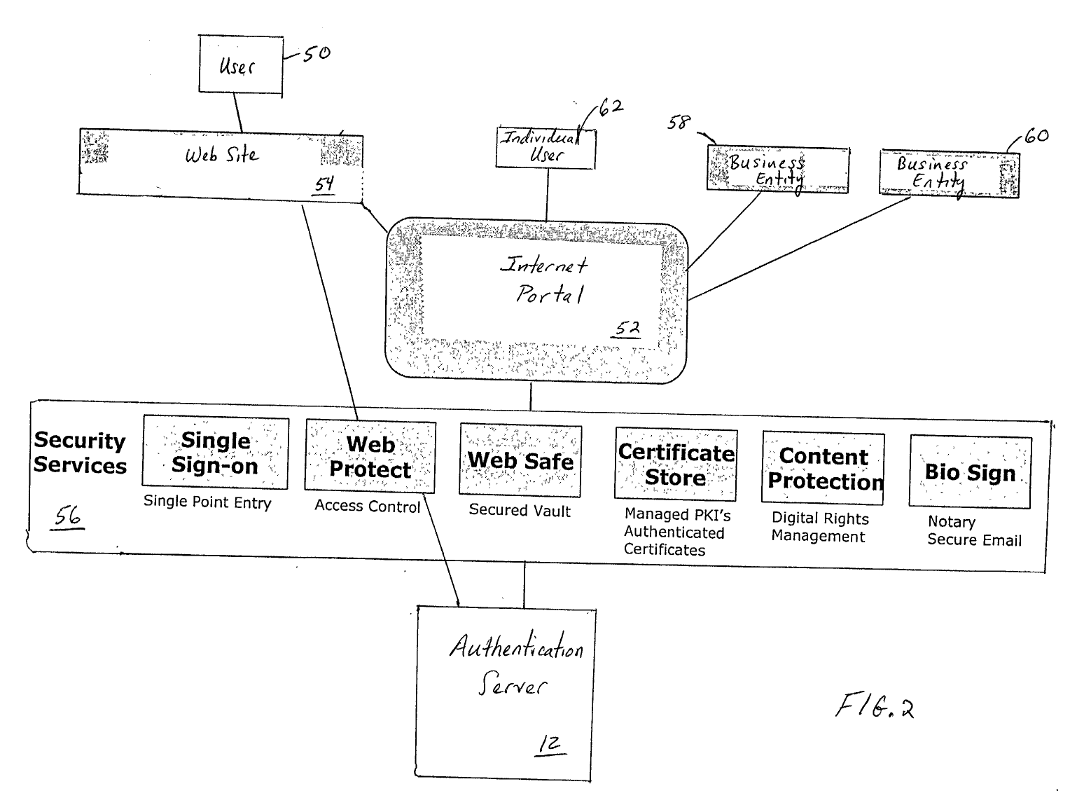

In another model, the authentication server 12 can be implemented as part of an application service provider's (ASP's) system in which the secure transaction services and the supporting infrastructure are provided by the ASP. In such a model, services would be provided to end-users in a transparent manner. For example, as shown in FIG. 2, a subscriber's computer system can be connected to the authentication server 12 through a subscription to a service (“Web Protect”) that requires a user 50 of the subscriber's system to be authenticated by the authentication server prior to being given access to information or applications available through the subscriber's web site 54. Additional services 56 that can be accessed only after authentication by the server 12 can be made available to subscribers through an Internet portal 52 to enhance the security of on-line transactions.

Potential users of the services associated with the authentication server 12 include horizontal and vertical markets. For example, horizontal markets that can advantageously use the authentication server 12 include the consumer and small office/home office (SOHO) markets. Vertical markets can include industry-specific markets such as the medical and financial industries, government agencies and general enterprise markets. Multiple business entities 58, 60 and users 62 can subscribe to services 56 made available through the portal 52. The business entities can include business-to-business as well as business-to-consumer entities. One or more of the secure services 56 can be bundled together and provided as part of a subscription to use the authentication server 12.

Examples of services 56 that can be accessed only after authentication by the server 12 are illustrated in FIG. 2. The services can include secure electronic mail (email), notary services, contract management, calendaring and access to a digital vault. Similarly, access to financial accounts, person-to-person payment services, trading services, electronic bill services, electronic wallet shopping services, investor services, travel services and other services can be provided through the portal 52. Prior to using the services 56, the user's credentials would be submitted to the server 12 for authentication.

Implementing the authentication server 12 as part of an independent, central service can allow an organization to out-source management of many of its security needs.

For example, a hospital administrator can subscribe to the security services offered through the web site. Once the administrator subscribes, the system generates a shared electronic key and a random password that are delivered to the administrator by certified mail or in some other secure manner. The administrator then downloads a software development kit to a web site associated with the hospital. The software development kit allows the administrator to customize security requirements for the hospital. The administrator can create user groups and identify which users or types of users are associated with each group. For example, the user groups may include a first group of medical doctors, a second group of nurses and a third group of hospital administration staff. Each user is associated with a particular role. The administrator can establish security settings for each user group as well as for individual users. The security settings indicate what information members of each group are permitted to access and the type of activities (if any) that members of each group are permitted to make with respect to the information stored in a secure server 36. Different user groups may have permission to access different types of information such as patient records, accounting data and insurance information stored in the secure server 36. Similarly, some users may be restricted in the actions they are permitted to take with respect to certain information. For example, some user groups may only be permitted to read the information in a particular file, whereas other groups may be permitted to modify the contents of the file as well.

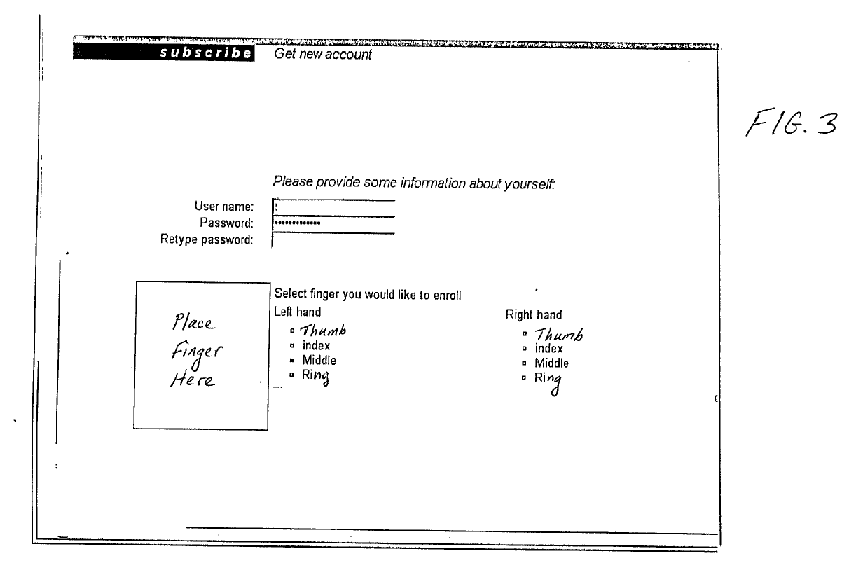

The administrator can establish user accounts and can enroll users directly. Alternatively, each user may be supplied with a one-time password that allows the user to enroll in the system. Initial enrollment may require that the user provide biometric information, for example, a fingerprint, as indicated by the enrollment page in FIG. 3. The information provided by the administrator, as well as profiles of the users, is sent to the server 12 where it can be encrypted and stored in a database 24 (FIG. 1). Personal information about the users, including user preferences and user credentials can be maintained in encrypted form in the database 24.

The system 10 permits secure communications between a client device 32 executing a browser 34 and the secure server 36 over a public network 38 such as the Internet. Authentication can be ensured not only of the client 34, but also of the user 40.

When a user 40 initially attempts to access the secure server 36, the secure server communicates with the server 12 to authenticate the user. In some implementations the secure server 36 and the authentications server 12 may communicate directly. However, to enhance security, communications that are sent over a public network such as the Internet 38, should be sent via the client 32. Communications can be sent, for example, over a Secure Socket Layer (SSL).

The user can be authenticated based on the user's credentials. Examples of user credentials that can be used to authenticate the user include information relating to “what the user has,” “who the user is,” and “what the user knows.” An example of “what the user has” is a smartcard. A smarteard is an electronic device the size of a credit card that includes an electronic memory storing information regarding a user that can be used for access to a secure entity. An example of “who you are” is biometric information. The biometric information can include information describing a user's fingerprint, facial scan, voice print, iris scan and the like. For example, a fingerprint is a useful biometric in ensuring the identity of a user. An example of “what you know” is a password.

Digital certificates also can be used to authenticate the user 40. The set of authentication information that is required to obtain a certificate can be embodied, for example, in a security policy module used by a certificate authority 14. The certificate authority 14 signs both the certificate and the authentication information at the time of registration. This binding process ensures that the certificate and the authentication information belong to the same individual.

To obtain a certificate, the user 40 can submit biometric information such as a fingerprint by placing a finger on fingerprint reader 42. The fingerprint reader 42 captures the fingerprint and generates information describing the fingerprint uniquely. The information can be referred to as a fingerprint “template” and includes “minutia” representing individual points of the fingerprint. The template is passed to the browser 34. The user also can enter additional identification information using a keyboard (not shown) attached to client 32. The browser 34 submits a certificate request which is submitted to the certificate authority 14. The certificate request includes the minutia and user identification information. The certificate authority 14 verifies the identification information, creates a user certificate, binds the certificate with the authentication information, stores the authentication information, and returns the certificate to the user 40. An encrypted version of the certificate also can be stored in the server 12.

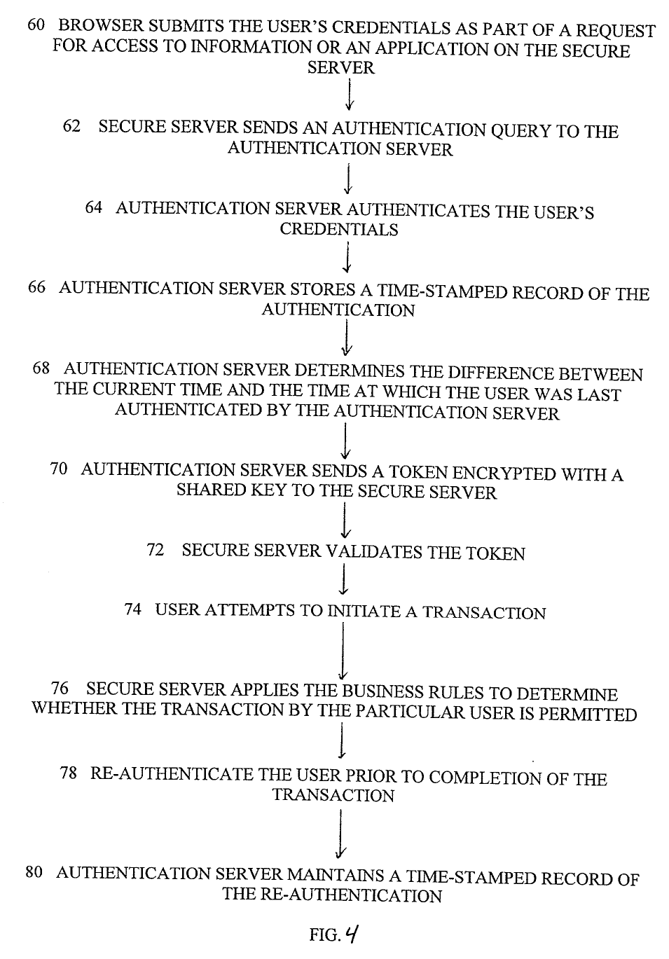

As shown in FIG. 4, to allow the user 40 to access the secure server 36, the browser 34 submits 60 the user's credentials as part of a request for access to information or applications on the secure server. The request may be submitted in response to a user command. As previously noted, the user's credentials can include biometric information such as the user's fingerprint, an electronic certificate and/or other information obtained, for example, from a smart card. Electronic devices such as the fingerprint reader 42 and smartcard reader 44 can be used to submit the user's credentials. Alternatively, user credentials such as an electronic certificate can be stored in the client device 32 and submitted automatically as part of the request to access the secure server 36.

After receiving the initial access request, the secure server 36 sends 62 an authentication query to the server 12. The authentication server 12 authenticates 64 the user's credentials and stores 66 a time-stamped record of the authentication. The authentication server 12 also determines 68 the difference between the current time and the time at which the user was last authenticated by the authentication server.

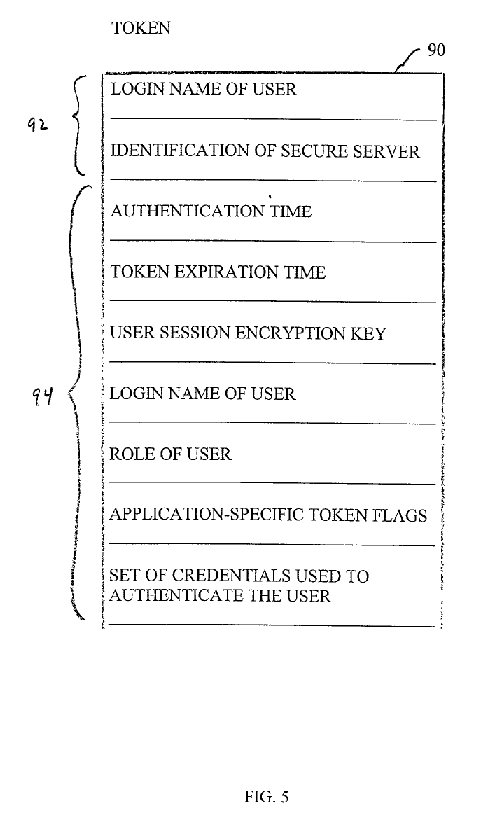

Assuming that the user is properly authenticated, the authentication server 12 sends 70 a token 90 (FIG. 5). The token can include a non-encrypted portion 92 and an encrypted portion 94. The encrypted portion 94 includes the user's login name and the name or other identification of the secure server 36. The encrypted portion 94 can be encrypted with a key shared by the authentication server 12 and the secure server 36. Alternatively, other encryption techniques based, for example, on the Public Key Infrastructure (PKI), can be used. Information embedded in the encrypted portion 94 of the token 90 includes the authentication time, the token expiration time, a user session encryption key, the user's login name, the user's role, application-specific token flags and the set of credentials used to authenticate the user.

Upon receiving the token 90, the secure server 36 validates the token by comparing 72 the difference between the current time and the authentication time to a predefined threshold. For example, a hospital might define the threshold as one month. Other durations may be used as the thresholds for other services. If the user has been authenticated by the server 12 within the past month, the user would be granted access to the hospital's secure server 36. If the calculated time is less than the threshold, a message indicating that access is granted to the secure server is sent to the browser 34.

Use of the threshold can eliminate the need for the user to authenticate with the server 12 each time he wishes to access information on the secure server 36. The user can simply authenticate with the server 12 once, and then access secure servers based on that authentication until a particular service requires the user to authenticate with the server 12 again. If the user does not have a valid token, for example, if the token has expired or if the pre-defined threshold is exceeded, the secure server 36 redirects the user automatically to the server 12 so that the user can be re-authenticated, if necessary, and can obtain a new token.

In some cases, two electronic digital tokens can be provided to a user whose credentials have been authenticated: a master token and a service-specific token. The service-specific token can be encrypted with a key that is provided to and shared by the authentication server 12 and the secure server 36. In the event that the service-specific token is no longer valid, the user can automatically obtain another service-specific token by submitting the master token to the authentication server 12.

In general, multiple servers like the secure server 36 may access and use the services provided by the authentication server 12. The authentication server 12 provides a different token for each secure server. Therefore, a user 40 may have multiple tokens each of which is associated with a different secure server 36.

In addition to providing authentication and validation services, the server 12 also provides transaction management services and content control and management services. The system 10 provides content protection by allowing specific information to be marked by a system administrator for specified types of use. For example, each page can be marked with business rules that indicate which users are authorized to take various types of actions with respect to the information accessible through the secure server 36. A particular user or group of users may be limited, for example, to viewing the content only once or for a limited duration during a specified time interval. Some user groups may be permitted to read certain information, but may not be allowed to copy, modify, print or forward that information. For example, hospital administrative staff as well as medical staff may be permitted to read patient medical records, but only specified physicians might be permitted to modify the patient's medical record. The hospital administrator can add commands to various web resources such as links and web pages associated with the secure server 36. Each command specifies the security requirements for the associated web page. A command may specify that a particular page can be accessed only if the user has been validated as a medical doctor on the hospital's staff by using particular biometric information such as a fingerprint.

The token 90 sent by the authentication server 12 to the secure server 36 also includes information that allows the secure server 12 to apply the business rules to the user. For example, the token 90 can include an identification of the user group to which the particular user belongs. A list of the applicable business rules also can be forwarded to the user 40 so as to indicate to the user the types of access and actions he is permitted to take with respect to stored files. When the user 40 attempts to initiate 74 a transaction with respect to a particular file or application on the secure server 36, the secure server applies 76 the business rules to determine whether the transaction by the particular user is permitted.

Assuming that the user is permitted to take the desired action, the user may be requested to resubmit his credentials so that he can be re-authenticated 78 prior to completion of the transaction. Re-authenticating the user may require, in some cases, that the user resubmit biometric information such as a fingerprint or information from a smart card. A record of the re-authentication is stored 80 in the database 24. By maintaining records of each authentication, an audit trail and non-repudiation can be provided. The record for each authentication can include the time and date of the authentication, as well as the identity of the authenticated user 40 and/or the application that requested the authentication. Time-stamped records also can be maintained of unsuccessful attempts to authenticate a user. The transaction records stored in the database 24, which can be encrypted to further enhance security, can be sent automatically to or accessed by an administrator of the secure server 36. Thus, the administrator of the secure server 3 6 can monitor attempted and actual transactions that occur in connection with the secure server.

The secure server 36 may request re-authentication of a user at other times as well. A time-stamped record of each authentication can be maintained in the database 24.

The secure transaction system 10 provides techniques for user authentication and validation, content control and transaction management. The system can provide enhanced security by authenticating the individual performing a particular transaction. Maintaining records of the user authentication in a secure manner makes it difficult for the user or the service provider to repudiate the transaction.

Various features of the system can be implemented in hardware, software, or a combination of hardware and software. Some aspects of the system, such as the authentication server 12 and the secure server 36, can be implemented in computer programs executing on programmable computers or processors. Each program can be implemented in a high level procedural or object-oriented programming language to communicate with a computer system. Furthermore, each such computer program can be stored on a storage medium, such as read-only-memory (ROM) readable by a general or special purpose programmable computer, for configuring and operating the computer when the storage medium is read by the computer to perform the functions described above.

Other implementations are within the scope of the claims.

What is claimed is:

1. A method comprising:
receiving a request by a user for access to a first server;
receiving a token at the first server, the token indicating that the user has been authenticated and including a role assigned to the user; and
determining, based at least in part on the role identified in the token, whether the user is permitted to perform a particular transaction in connection with a specified file or application at the first server.

2. The method of claim 1 including:
generating the token at a second server; and sending the token to the first server via a public network.

3. The method of claim 1 including:
authenticating the user; and
sending the token to the first server after authenticating the user, the token including a set of credentials used to authenticate the user.

4. The method of claim 3 wherein the token identifies a time at which the user was authenticated, the method including validating the token based on the authentication time and a predefined threshold.

5. The method of claim 3 including storing a time-stamped record of the user authentication in a database.

6. A method comprising:
receiving a request for access to a first server by a user, the request including credentials of the user;
authenticating the user based on the credentials;
sending a token to the first server, the token indicating whether the user has been authenticated and including criteria about the user; and
determining, based on the criteria in the token, whether the user is permitted to perform a particular transaction in connection with a specified file or application at the first server.

7. The method of claim 6 including storing a time-stamped record of the authentication.

8. The method of claim 6 including:
re-authenticating the user prior to allowing the transaction to be completed; and
storing a time-stamped record of the re-authentication.

9. The method of claim 6 including determining the validity of the token with respect to the first server.

10. The method of claim 6 wherein the user credentials include an electronic certificate.

11. The method of claim 1 wherein the user credentials include biometric information.

12. The method of claim 6 including encrypting the token with a shared key and sending the encrypted token to the secure server.

13. The method of claim 6 wherein the criteria in the token includes an indication of a role assigned to the user.

14. The method of claim 6 wherein determining whether the user is permitted to perform a particular transaction includes examining the criteria in the token and a business rule.

15. The method of claim 6 including re-authenticating the user based on the credentials.

16. The method of claim 6 including determining, based on the criteria in the token, whether the user is authorized to access a particular file or application.

17. The method of claim 6 including determining, based on the criteria in the token, whether the user is authorized to modify a particular file.

18. The method of claim 6 including determining, based on the criteria in the token, whether the user is authorized to forward a particular file.

19. The method of claim 6 including determining, based on the criteria in the token, whether the user is authorized to print a particular file.

20. A method comprising:
receiving a request for access to a first server by a user, the request including biometric credentials of the user;
authenticating the user based on the biometric credentials;
sending a token to the first server, the token indicating whether the user has been authenticated and identifying a role assigned to the user;
determining, based on the role identified in the token, whether the user is authorized to perform a particular transaction in connection with the first server;
re-authenticating the user prior to allowing the transaction to be completed; and
storing time-stamped records of the authentication and re-authentication of the user.

21. The method of claim 20 including encrypting at least a portion of the token with a shared key and sending the encrypted token to the secure server.

22. The method of claim 21 including determining the validity of the token with respect to the first server.

23. A system comprising:
a first server; and
an authentication server configured to:
receive a request for access to the first server by a user, the request including credentials of the user;
authenticate the user based on the credentials;
store a time-stamped record of the authentication; and
send a token to the first server, the token indicating whether the user has been authenticated and including criteria about the user; and
the first server configured to determine, based on the criteria in the token, whether the user is permitted to perform a particular transaction in connection with the first server.

24. The system of claim 23 wherein the first server is configured to examine the criteria in the token and a business rule to determine whether the user is authorized to perform the particular transaction.

25. The system of claim 23 wherein the first server is configured to request re-authentication of the user prior to allowing the transaction to be completed.

26. The system of claim 25 wherein the authentication server is configured to store a time-stamped record of the re-authentication.

27. The system of claim 23 wherein the first server is configured to determine the validity of the token received from the authentication server.

28. The system of claim 23 wherein the authentication server is configured to encrypt at least a portion of the token with a shared key and to send the encrypted token to the first server.

29. A system comprising:
a secure server;
a database for storing a user profile and criteria about the user, the criteria being established by an administrator of the secure server; and
an authentication server configured to:
receive a request for access to the secure server by a user, the request including credentials of the user;
authenticate the user based on the credentials and the user profile stored in the database;
store a time-stamped record of authentication of the user in the database; and
send a token to the secure server, the token indicating whether the user has been authenticated and including the criteria about the user from the database,
the secure server configured to use the criteria about the user in the token in conjunction with a business rule established by the administrator to determine whether the user is authorized to perform a particular transaction in connection with a specified file or application at the secure server.

30. The system of claim 29 wherein the secure server is configured to request re-authentication of the user prior to allowing the transaction to be completed.

31. The system of claim 30 wherein the authentication server is configured to store a time-stamped record of the re-authentication in the database.

32. The system of claim 31 wherein the secure server is configured to determine the validity of the token received from the authentication server.

33. The system of claim 29 wherein the user's credentials include biometric information.

34. The system of claim 33 including:
a network coupled to the secure server and the authentication server;
a user device that can execute a browser and that is coupled to the network; and
a fingerprint reader coupled to the user device and that can be used by the user to submit the biometric information.
